(19) United States
(12) Patent Application Publication
(10) Pub. No.: US 2023/0166870 A1
(43) Pub. Date: Jun. 1, 2023

(54) REPAIR ASSEMBLY FOR AIRCRAFT STATIC PRESSURE PORT

(71) Applicant: Airbus Operations SAS, Toulouse (FR)

(72) Inventors: Bruno CHAUVEAU, TOULOUSE (FR); Olivier COLLIN, TOULOUSE (FR); Olivier CHAUVET, TOULOUSE (FR)

(21) Appl. No.: 17/993,165

(22) Filed: Nov. 23, 2022

(30) Foreign Application Priority Data
Nov. 30, 2021 (FR) 2112719

(51) Int. Cl. B64F 5/40; B64C 1/12; B29C 73/10; B29C 73/26

(52) U.S. Cl. CPC B64F 5/40; B64C 1/12; B29C 73/10; B29C 73/26; B29C 2073/264

(57) ABSTRACT

A method for repairing a damaged aircraft fuselage outer skin part, the damaged skin part comprising a static pressure port around which is arranged a stopper fastened to a structure of the fuselage at which a pipe of the static pressure port opens, the method including removing the stopper from the static port, fitting a patch including an opening for housing the stopper, and re-fitting the stopper on an adjustable-thickness spacer. A repair assembly configured to apply the repair method is also provided. Advantageously, it is thus possible to recreate an aerodynamic profile in accordance with the requirements for taking static pressure of the aircraft, with a reduced down-time of the aircraft.

### CROSS-REFERENCES TO RELATED APPLICATIONS

This application claims the benefit of the French patent application No. 2112719 filed on Nov. 30, 2021, the entire disclosures of which are incorporated herein by way of reference.

### FIELD OF THE INVENTION

The present invention relates to a repair method for an aircraft fuselage. The invention relates more particularly to a method and assembly for repairing a fuselage portion situated near a static pressure port of an aircraft.

### BACKGROUND OF THE INVENTION

Outer skins of aircraft are sometimes subjected to damage, in particular as a result of bird strikes, but also collisions with tooling, airport vehicles or else airport facilities. Impacts created by collisions cause damage zones that are liable to exhibit modifications in terms of mechanical strength, in which zones structural defects may appear. In addition, certain zones of the fuselage of an aircraft are particularly critical and, besides the strength modifications that are liable to occur following a collision, shape modifications can lead to aerodynamic modifications around a static pressure port.

Static pressure ports, which are usually situated on each side of the fuselage, at the front of an aircraft, have openings for measuring the pressure of the air around the aircraft. In most cases, a plurality of openings are arranged perpendicular to the stream lines of the flow of air over the fuselage, so as to obtain a reference pressure measurement that, compared with a dynamic pressure measured in a direction parallel to the movement of the aircraft, makes it possible to define the speed of this aircraft in the air (also called airspeed). Thus, a variation in flow of the air around a static pressure port, as a result of deformation of the skin of the fuselage around this port, can substantially distort the measurement of the airspeed of the aircraft, which is measured via this port. Now, the airspeed is a very important parameter in all the flight phases of an aircraft. The presence of a damage zone near a static pressure port requires the entire lateral panel on which the static pressure port is installed to be changed. Such maintenance often requires a very long down-time of the aircraft, and a multitude of complex operations on the structure and the on-board systems of the aircraft.

The situation has room for improvement.

### SUMMARY OF THE INVENTION

An object of the present invention is to propose a repair method that allows the down-time of the aircraft to be reduced.

To this end, there is proposed a method for repairing a damaged fuselage outer skin part, the damaged skin part comprising a static pressure port around which is arranged a stopper fastened to a structure of the fuselage having an opening at which a pipe of the static pressure port opens, the method being characterized in that it comprises:
removing the stopper from the static pressure port,
fitting and fastening a fuselage skin patch dimensioned so as to cover the damaged part, the patch comprising a through-opening configured such that the stopper can be housed therein,
positioning a stopper spacer against the structure of the fuselage, the stopper spacer being configured such that the outer surface of the stopper exhibits surface continuity with the surface of the patch around the through-opening,
fitting the stopper on the stopper spacer and fastening the stopper to the structure of the fuselage.

Advantageously, it is thus possible to recreate an aerodynamic profile in accordance with the requirements for taking static pressure of the aircraft, with a reduced down-time of the aircraft.

The repair method according to the invention may also have the following features, considered alone or in combination:
The stopper spacer comprises a thickness of peelable material.
The stopper spacer is made up of a first spacer on which is fitted a second spacer, the second spacer being made of the peelable material.
The method comprises, prior to the step of positioning the patch, cutting out the damaged fuselage skin part and fitting a filling spacer taking the shape of the cut-out part before damage in the cavity created by the cutting-out.
The repair method comprises, prior to the fitting of the skin patch, a step of determining minimum distances between the opening arranged in the stopper and outer edges of the patch.

Another subject of the invention is an assembly for repairing a damaged fuselage outer skin part, the damaged skin part comprising a static pressure port around which is arranged a stopper fastened to a structure of the fuselage at which a pipe of the static pressure port opens, the repair assembly comprising:
a fuselage skin patch dimensioned so as to cover the damaged part, the patch comprising a through-opening configured such that the stopper can be housed therein,
a stopper spacer configured to be positioned and fastened against the fuselage structure, the stopper spacer being configured so that the outer surface of the stopper exhibits surface continuity with the surface of the patch around the through-opening when the patch is positioned on the fuselage skin, around the static pressure port.

Advantageously, the repair assembly comprises fastening means with a countersunk head.

### BRIEF DESCRIPTION OF THE DRAWINGS

The abovementioned features of the invention, along with others, will become more clearly apparent upon reading the following description of one exemplary embodiment, the description being given with reference to the appended drawings, in which:

FIG. 1 is an exploded view illustrating a repair assembly before joining according to one embodiment;

FIG. 2 is a block diagram illustrating the repair assembly already shown in FIG. 1, after joining to the fuselage of an aircraft;

FIG. 3 is a diagram showing steps of a repair method according to one embodiment, by virtue of the repair assembly visible in FIG. 1 and FIG. 2; and

FIG. 4 is a cross section of the repair assembly joined to the fuselage skin of the aircraft by application of the repair method illustrated in FIG. 3.

### DETAILED DESCRIPTION OF THE PREFERRED EMBODIMENTS

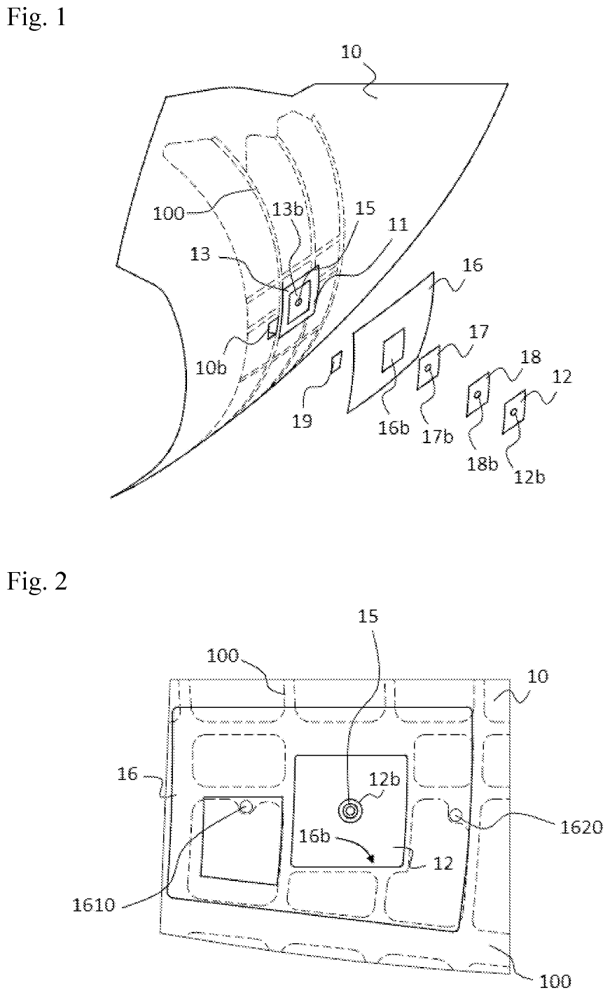

FIG. 1 shows a fuselage outer skin portion 10 of an aircraft having a damaged zone 10b near a static pressure port 11. The skin portion 10 is joined to a fuselage structure 100 arranged in the form of a network of ribs and/or frames and/or other elements of the primary structure of the aircraft. The damaged zone 10b is, according to the example described, a dent linked to a bird strike. The proximity of the dented zone to the static pressure port 11 is such that the flow of the streams of fluid (air) during the flight phases of the aircraft is not in accordance with the predicted nominal aerodynamics conditions that are required in order to ensure high precision of the airspeed measurement. Specifically, if the streams of fluid do not flow in a direction identical to that expected, a dynamic pressure is potentially detected in the static pressure port pipe, and this consequently distorts the measurement of the airspeed. The static pressure port 11 comprises the end of a static pressure port pipe 15 that opens, via an opening 13b made in the structure 13 of the fuselage, outside the aircraft. The static pressure port 11 makes it possible to obtain, in the static pressure port pipe 15, a pressure representative of the air pressure outside the aircraft. The end of the static pressure port pipe 15 is arranged so as to be at right angles to the stream lines of the flow of air at the exterior location at which the pipe 15 opens onto the wall of the fuselage (onto the fuselage outer skin). A stopper 12 makes it possible to cover the static pressure port 11 and its immediate surroundings, and therefore the opening 13b in the structure 13 that the pipe 15 of the static pressure port 11 passes through. The stopper 12 has a static pressure port opening 12b, arranged facing the end of the static pressure port pipe 15 opening at the surface of the fuselage of the aircraft. Most generally, the static pressure port of an aircraft is arranged at the front of the airframe of the aircraft, beneath the cockpit. Depending on the aircraft model, the static pressure port stopper may comprise more than one static pressure port opening. Thus, on large-sized airliners, the stopper conventionally comprises a plurality of openings disposed in the shape of a cross or rosette usually comprising a central opening, an upper opening, a lower opening, a front opening and a rear opening. For the sake of simplification, a single opening 12b is shown on the stopper 12. Advantageously, a repair assembly (or kit) is proposed that makes it possible to substantially decrease the time spent working on the aircraft comprising the fuselage outer skin portion 10. The repair assembly comprises a fuselage skin patch 16, also called skin patch 16 or patch 16 here, and a first spacer 17 and a second spacer 18, which second spacer 18 is used as adjustment spacer. Thus, the two spacers 17 and 18 may cooperate so as to constitute an adjustable-thickness spacer. More specifically, the first spacer 17 makes it possible to add a fixed thickness between the structure 13 and the stopper 12, and the second spacer 18, which is made of peelable material, makes it possible to add a variable thickness to the fixed thickness. Specifically, since the second spacer 18 is made of a peelable material, its thickness can be adjusted differently at a plurality of points. For example, the second spacer 18 may have, after peeling (therefore after adjustment of its thickness), distinct thicknesses depending on the precise location considered. Thus, a first corner of the second spacer 18 may have a thickness different to that of a second corner of the spacer 18, if the spacer 18 has a parallelepipedal shape. The patch 16 comprises an opening 16b configured such that the stopper 12 can be housed therein. Of course, the first and second spacers 17 and 18 each have a central opening for the passage of the air, or else for the passage of the end of the static pressure port pipe 15, depending on the arrangement of the latter with a view to being able to take a static pressure. The first spacer 17 comprises an opening 17b and the second spacer 18 comprises an opening 18b. According to one embodiment of the invention, the repair assembly also comprises one or more filling spacers to be cut so as to fill the one or more damaged parts of the fuselage skin, such as the filling spacer 19 illustrated in FIG. 1 and provided to fill a cutout made around the damaged zone 10b. The filling spacer 19 may advantageously be fastened to the patch 16, on the inside thereof, in order to prevent the accumulation of water in one or more dented parts of the fuselage skin, and consequently to prevent the occurrence of corrosion phenomena. Each filling spacer used to do this has to be cut so as to adjust the dimensions thereof to a cutout previously made in the fuselage outer skin. Thus, for each damaged zone of the fuselage outer skin, a cutout is made around the zone with the aim of removing the entire damaged zone, and the cavity resulting from the cutting-out is filled with a filling spacer portion. Advantageously, the patch 16 is fastened to the fuselage outer skin by means of fastening elements with countersunk heads, so as to prevent the elements from protruding on the surface of the fuselage and disturbing the flow of the streams of air in the skin zone around the static pressure port. According to one embodiment, the nominal fastenings are replaced by fasteners with countersunk heads. Advantageously, the dimensions of the patch 16 are adapted to the dimensions of the damaged zone of the damaged fuselage part 10. The zones having variations in surface state that are induced by a collision or deformation of any origin have to be covered by the patch 16. Furthermore, the edges of the patch 16 have to be sufficiently far away from the static pressure port 11 (or more specifically from the one or more openings 12b in the stopper 12 joined to the static pressure port 11) to prevent the relief that an outer edge of the patch embodies from being able to cause turbulence that is liable to negatively affect the flow of the air at the static pressure port 11. The dimensions of the patch 16 may advantageously be determined so as to cover a plurality of dented or damaged zones of the fuselage outer skin.

FIG. 2 schematically illustrates the surroundings of the static pressure port 11 after repair of the damaged fuselage outer skin part 10 near the static pressure port 11. The patch 16 is joined to the fuselage outer skin part 10 after the one or more damaged zones have been cut out and each filled with filling spacers (which are similar to the filling spacer 19 illustrated in FIG. 1). The static pressure port 11 opens at the opening 12b arranged in the stopper 12. The static pressure port stopper 12 is positioned in the opening 16b arranged in the fuselage outer skin patch 16. Fastening elements of the countersunk screw type are used to tightly fasten the patch to the fuselage. According to the example described, the fastening elements 1610 and 1620 are inserted into ribs (or frames) of the primary structure 100 of the fuselage. Of course, numerous other similar fastening elements are used to fasten the patch 16 to the fuselage outer skin, but are not shown in the figures in order to make the latter easier to understand. Advantageously, the minimum dimensions of the patch 16, and, in particular, its minimum dimension along the longitudinal axis of the aircraft, are defined by aerodynamic tests previously carried out on the ground and/or in flight during design and testing phases applied to the type of aircraft in question (on which the patch 16 can be mounted) or else by modelling. According to one embodiment of the invention, the maximum heightwise dimension of the patch 16 is established with respect to the dimensions of a fuselage outer skin panel to which the patch is joined or else as a function of the dimensions of the inter-frame spaces of the primary structure of the fuselage in the surroundings of the static pressure port. For example, as regards the height of the patch 16, the maximum dimension is preferentially limited to half the total height of the fuselage panel to which the patch is fastened, so as to prevent the patch 16 from having too great an influence on the mechanical behavior of this fuselage panel (strength, vibrational profile, etc.).

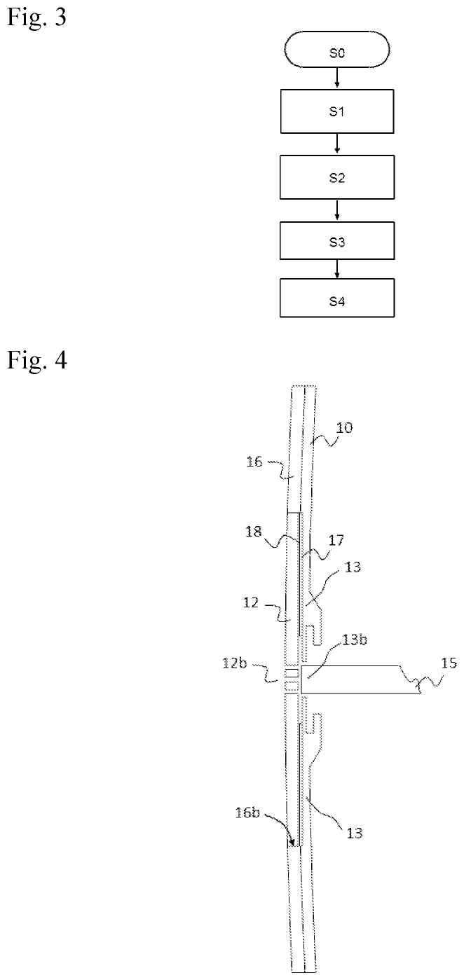

FIG. 3 is a diagram illustrating essential steps of a method for repairing the damaged part 10 of a fuselage outer skin using the repair assembly described previously comprising the patch 16 and the spacers 17 and 18. Step S0 is an initial step at the end of which the aircraft having at least one damaged fuselage outer skin zone in its damaged part 10 is disposed in a maintenance site and prepared for repair of the damaged part. During a step S1, the static pressure port stopper 12 and the one or more original spacers for positioning the stopper 12 are removed and the damaged zones are cut out. The term original spacers is understood here to mean spacers positioned during manufacture of the aircraft or during an earlier maintenance operation. The cutting-out performed makes it possible to systematically eliminate any relief modification (dimple or bump) induced by a collision. In this step, visual inspection is conventionally carried out and non-destructive testing implementing eddy currents is performed, in order to verify the absence of cracks. During a step S2, the patch 16 is joined to the fuselage outer skin and then an adjusted-thickness spacer is put in place, during a step S3, in the opening 16b in the patch, which spacer is configured to be disposed facing the native position of the static pressure port stopper 12. The adjusted-thickness spacer may be a single spacer comprising a peelable thickness or else a combination of a first, fixed-thickness spacer, made of non-peelable material, and a second spacer, made of peelable material. Advantageously, the use of a peelable material for a thickness of spacer beneath the stopper 12 makes it possible to position and fasten, during a step S4, the stopper 12 removed during the step S1 (or a new stopper similar to the stopper 12), so as to eliminate any lack of flushness of the surface of the part 10 as a result of a difference in level between all or some of the surface of the patch 16 and all or some of the surface of the stopper 12. Advantageously, the thickness of the peelable part of the spacer is determined so as to prevent any surface discontinuity around the static pressure port 11, i.e., in other words so as to ensure surface continuity between the surface of the stopper 12 and the surface of the patch 16. According to a preferred embodiment of the repair method, the spacer comprising a thickness of peelable material is made up of the first spacer 17, which is intended to perform filling, and the second spacer 18, which is made of peelable material and is intended to make it possible to adjust the total thickness of spacer between the structure 13 on which the first spacer 17 bears and the stopper 12 that bears on the second spacer 18, which itself bears on the first spacer 17. According to one embodiment of the invention, the patch 16 is made of Alu Clad 2024T42 material and the first spacer 17 is made of Alu Clad 2024T3 material. According to one embodiment, the cumulative thickness of the first spacer 17 and the second spacer 18 before peeling is smaller than the thickness of the patch 16 or the thickness of the fuselage outer skin, and this makes it possible to limit the operations of peeling for eliminating a lack of flushness.

Advantageously, the one or more filling spacers (which are similar to the filling spacer 19 shown in FIG. 1), which are used to fill the damaged zones cut out from the fuselage outer skin of the damaged part 10, are made of Alu Clad 2024T3 material.

The stopper 12 itself is also fastened by means of fastening elements with countersunk heads.

FIG. 4 is a vertical cross section of the fuselage skin part 10 after the repair method illustrated in FIG. 3 has been carried out, with the aid of the repair assembly made up of the patch 16, the first spacer 17 and the second, peelable spacer 18. The static pressure port end 15 is arranged facing the openings in the stopper 12. The stopper 12 has a shape complementary to the opening 16b for housing the stopper 12, which opening is arranged in the fuselage outer skin patch 16. The patch 16 is fastened to the fuselage outer skin part 10 that was previously damaged. The fastening means are not shown in FIG. 4, since they are not useful for good understanding of the invention.

The lack of flushness between the surface of the stopper 12 and the surface of the patch 16 is advantageously and ingeniously obtained by adjustment of the peelable spacer 18 superposed on the spacer 17, the spacers being disposed (“sandwiched”) between the fuselage structure 13 around the opening 13b allowing the static pressure to be taken.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

1. A method for repairing a damaged outer skin part of a fuselage, said damaged skin part comprising a static pressure port around which is arranged a stopper fastened to a structure of the fuselage and comprising a static pressure port opening at which a pipe of the static pressure port opens, the method comprising the steps of:
removing said stopper from the static pressure port,
fitting and fastening a fuselage skin patch dimensioned so as to cover said damaged part, said patch comprising a through-opening configured such that said stopper can be housed therein,
positioning a spacer against said structure of the fuselage, the spacer being configured such that an outer surface of the stopper to be fitted exhibits surface continuity with the surface of said patch around the through-opening,
fitting said stopper on said spacer in said opening arranged in the patch and fastening said stopper to said structure of the fuselage.

2. The repair method according to claim 1, wherein said spacer comprises a thickness of peelable material.

3. The repair method according to claim 2, wherein said spacer is made up of a first spacer on which is fitted a second spacer, said second spacer being made of said peelable material.

4. The repair method according to claim 1, comprising, prior to the step of positioning said patch, a step of cutting out the damaged skin part and fitting a filling spacer taking a shape of said damaged skin part which has been cut out, before damage.

5. The repair method according to claim 1, comprising, prior to the fitting of the skin patch, a step of determining minimum distances between said opening arranged in the stopper and outer edges of said patch.

6. An assembly for repairing a damaged outer skin part of a skin of a fuselage, said damaged skin part comprising a static pressure port around which is arranged a stopper fastened to a structure of the fuselage at which a pipe of said static pressure port opens, the repair assembly comprising:
a skin patch dimensioned to cover said damaged part, said patch comprising a through-opening configured such that said stopper can be housed therein,
a stopper spacer configured to be positioned and fastened against said fuselage structure, the stopper spacer also being configured so that an outer surface of the stopper exhibits surface continuity with the surface of said patch around the through-opening when said patch is positioned on said fuselage skin, around the static pressure port.

7. The repair assembly according to claim 6, wherein said stopper spacer comprises a thickness of peelable material.

8. The repair assembly according to claim 7, wherein said stopper spacer is made up of a first spacer on which is fitted a second spacer, said second spacer being made of said peelable material.

9. The repair assembly according to claim 6, comprising fastening means with a countersunk head.
